(19) United States
(12) Patent Application Publication
(10) Pub. No.: US 2011/0291402 A1
(43) Pub. Date: Dec. 1, 2011

(54) Privacy Cover System

(76) Inventor: Shawn M. Asbenson, Salem, OR (US)

(21) Appl. No.: 12/163,474

(22) Filed: Jun. 27, 2008

(51) Int. Cl. B42D 15/00

(52) U.S. Cl. 283/109

(57) ABSTRACT

A privacy cover system for efficiently increasing the privacy of an information card by reducing the visibility of the card at offset angles. The privacy cover system generally includes a privacy cover to attach to an information card over at least a portion of information upon the information card, wherein the privacy cover aligns with the information of the information card. The privacy cover is adapted to allow viewing of the information of the information card through the privacy cover over a first range of angles (i.e. viewing angles) and is adapted to prevent viewing of the information of the information card through the privacy cover over a second range of angles (i.e. restricting angles).

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to information cards and more specifically it relates to a privacy cover system for efficiently increasing the privacy of an information card by reducing the visibility of the card at offset angles.

2. Description of the Related Art

Any discussion of the related art throughout the specification should in no way be considered as an admission that such related art is widely known or forms part of common general knowledge in the field.

Information cards have been in use for years and are utilized by many people as a means to identify themselves or a particular item, and also as a means of payment such as in credit cards. Information cards generally include enough information to identify the individual or the particular account or purpose of the card. This can make various types of information cards popular among individuals in that they are often easy to carry around and utilize.

It can be very easy for a nearby individual to “peek” over the shoulder, photograph or get a glance at another individual's information card. In addition, the nearby individual may be able to peek long enough to take notice of, remember and photograph a particular identification number or characteristic upon the information card. This can result in the nearby individual using the other's information card or knowledge of their card without consent. Because of the inherent problems with the related art, there is a need for a new and improved privacy cover system for efficiently increasing the privacy of an information card by reducing the visibility of the card at offset angles.

### BRIEF SUMMARY OF THE INVENTION

The general purpose of the present invention is to provide a privacy cover system that has many of the advantages of the information cards mentioned heretofore. The invention generally relates to an information card which includes a privacy cover to attach to an information card over at least a portion of information upon the information card, wherein the privacy cover aligns with the information of the information card. The privacy cover is adapted to allow viewing of the information of the information card through the privacy cover over a first range of angles (i.e. viewing angles) and is adapted to prevent viewing of the information of the information card through the privacy cover over a second range of angles (i.e. restricting angles).

There has thus been outlined, rather broadly, some of the features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide a privacy cover system for efficiently increasing the privacy of an information card by reducing the visibility of the card at offset angles.

Another object is to provide a privacy cover system that may be utilized with various types of information cards, such as but not limited to credit cards, debit cards, driver's licenses and playing cards.

An additional object is to provide a privacy cover system may be easily placed upon a card, such as through laminate means, other adhesive means or manufactured directly with the card.

A further object is to provide a privacy cover system that allows the card to be visible from a straight on angle but not visible from an offset angle.

Another object is to provide a privacy cover system that may reduce the amount of identification theft in that individuals will not be able to easily see another's information card information.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention exploded from an information card, wherein the information card is comprised of a transaction card.

FIG. 2 is a front view of the present invention attached to an information card, illustrating the card at a straight on viewing angle.

FIG. 3 is an upper perspective view of the present invention attached to an information card, illustrating the card slightly rotating toward a restricting view and a portion of the information becoming covered as the card is being rotated.

FIG. 4 is an upper perspective view of the present invention attached to an information card, illustrating the card at a skew restricting angle.

FIG. 5 is a longitudinal cross-sectional view of the present invention attached to an information card.

FIG. 6 is an upper perspective view of the present invention attached to an information card, illustrating the card at a skew restricting angle and the present invention sized to cover only the information of the credit card illustrating the account number.

FIG. 7 is an upper perspective view of the present invention exploded from an information card, wherein the information card is comprised of a playing card.

### DETAILED DESCRIPTION OF THE INVENTION

### A. Overview

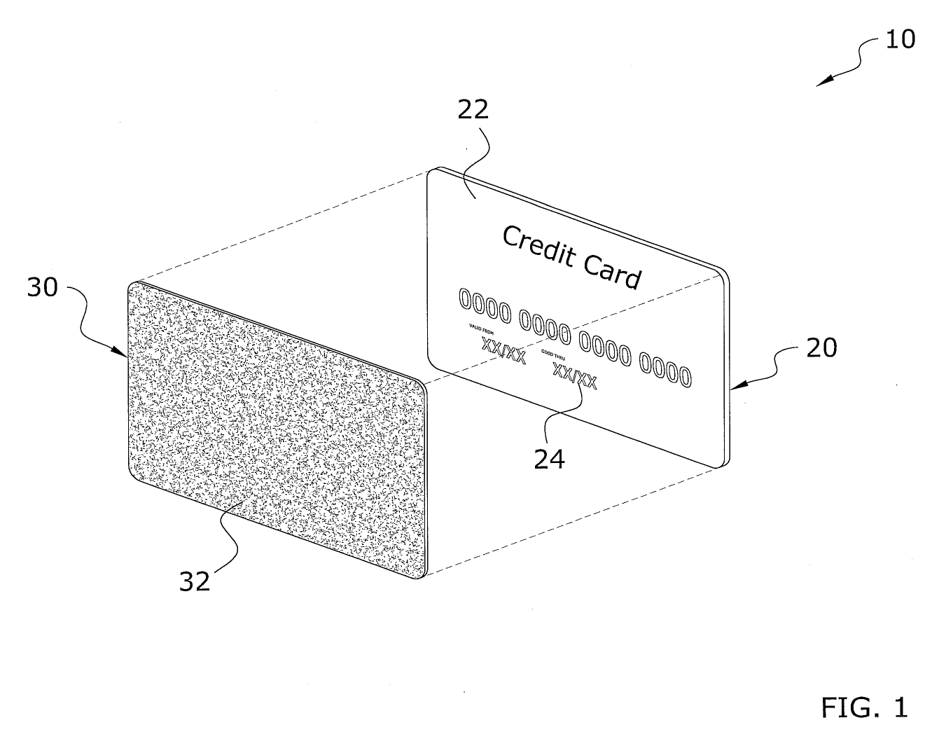

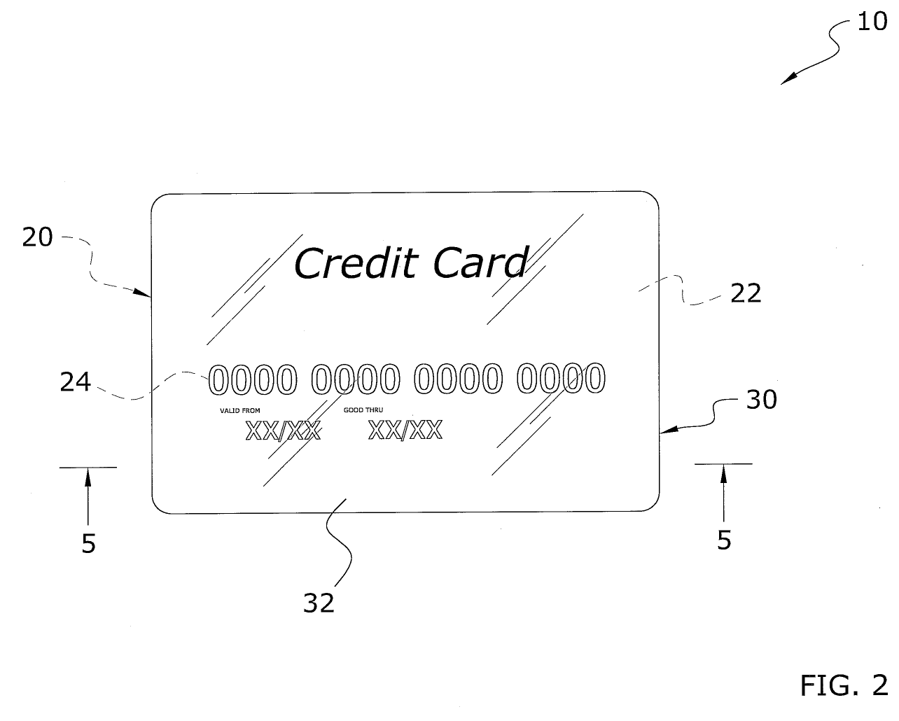

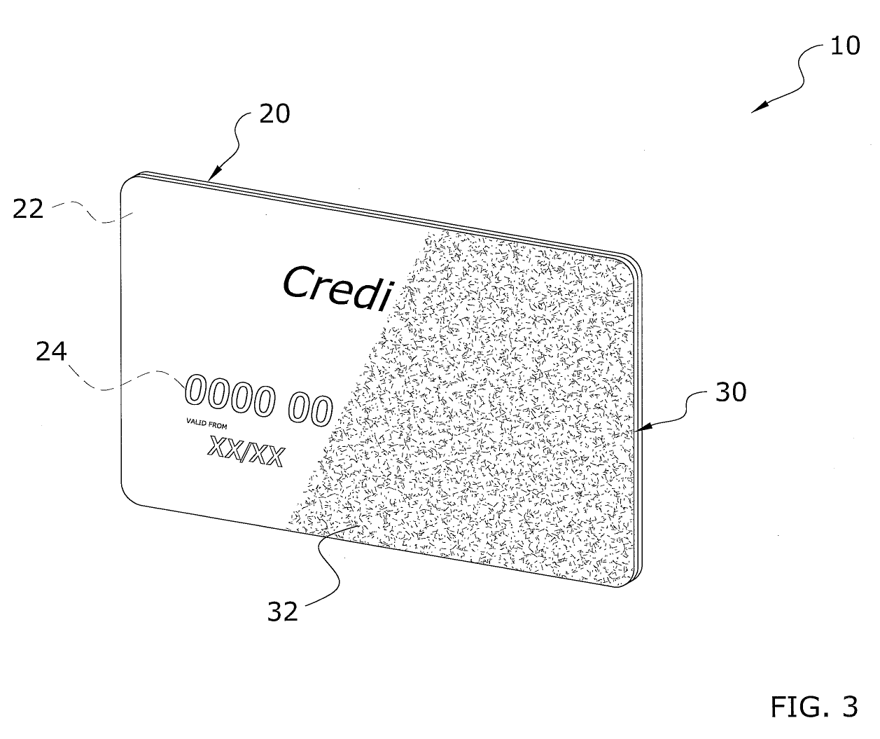

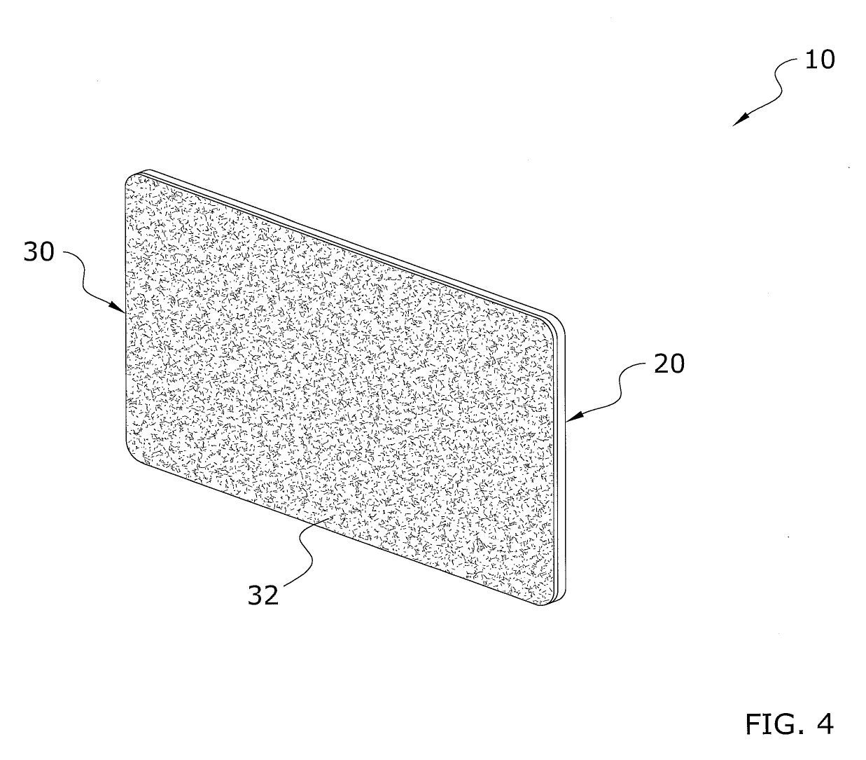

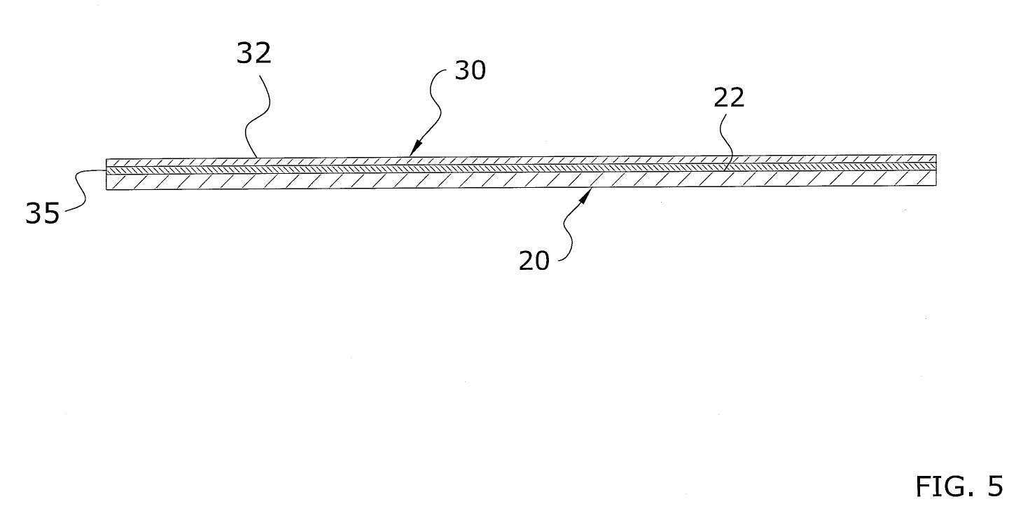

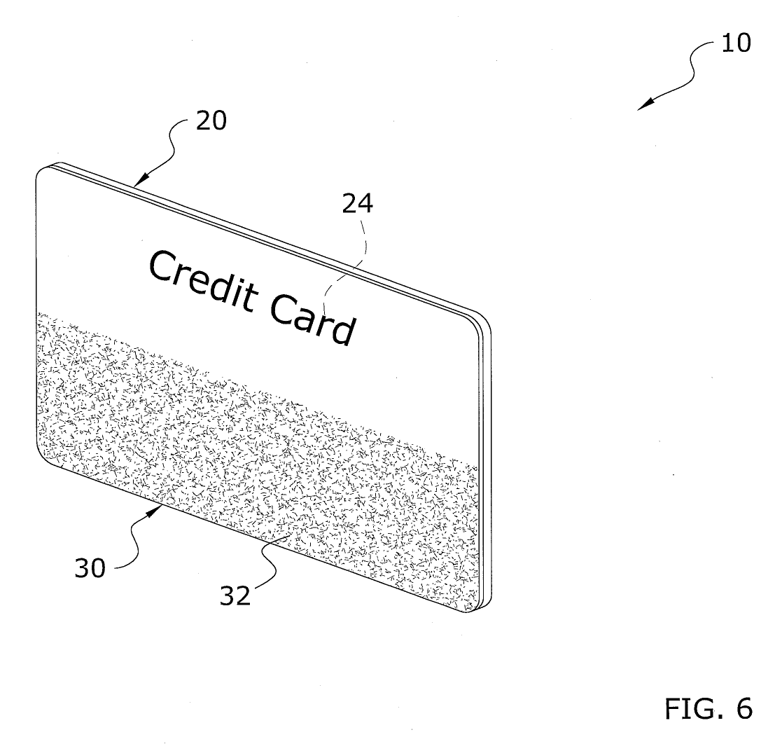

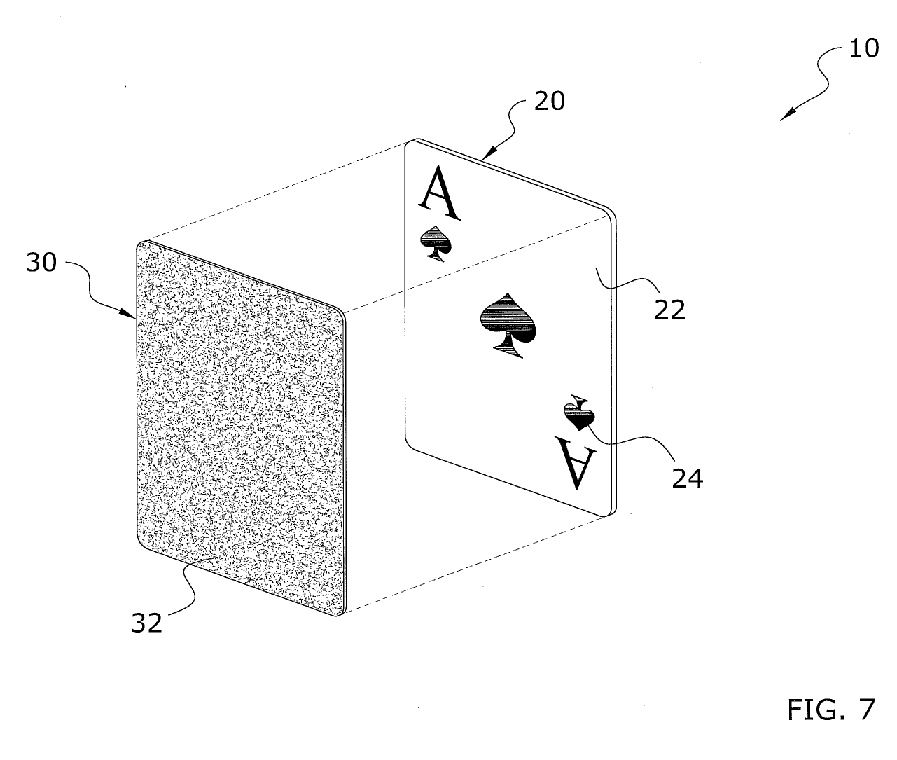

Turning now descriptively to the drawings, in which similar reference characters denote similar elements throughout the several views, FIGS. 1 through 7 illustrate a privacy cover system 10, which comprises a privacy cover 30 to attach to an information card 20 over at least a portion of information 24 upon the information card 20, wherein the privacy cover 30 aligns with the information 24 of the information card 20. The privacy cover 30 is adapted to allow viewing of the information 24 of the information card 20 through the privacy cover 30 over a first range of angles (i.e. viewing angles) and is adapted to prevent viewing of the information 24 of the information card 20 through the privacy cover 30 over a second range of angles (i.e. restricting angles).

### B. Information Card

The information card 20 may be comprised of various types of cards 20 that a user desires to restrict view of information 24 upon the card 20 when the card 20 is at various angles. The information card 20 may be comprised of such cards 20 as transaction cards 20, such as a credit card 20 or a debit card 20, or a playing card 20, or identification cards 20, such as a driver's license, passport, an employment identification card 20, a student identification card 20 or various other types of cards 20 that include personal or confidential information 24 upon the card 20. The information card 20 may be comprised of various sizes, wherein the privacy cover 30 may adapt to the entire or partial size of the information card 20 so as to suitably cover 30 the information 24 upon the card 20.

The information card 20 generally includes a first face 22. The first face 22 includes various types of information 24 to identify the user of the card 20. The information 24 may be comprised of an account number, a name, a date, a photograph or various other types of information 24. It is appreciated that the information 24 may also be positioned upon various other places of the card 20 rather than the first face 22, wherein multiple privacy covers 30 may need to be used to cover 30 all of the information 24.

### C. Privacy Cover

The privacy cover 30 attaches to the first face 22 of the card 20 over the information 24 upon the first face 22 of the card 20. The privacy cover 30 is transparent and allows a user to view and read the information 24 upon the card 20 at certain viewing angles and prevents a user from reading the information 24 (i.e. via causing a reflection) upon the card 20 at certain restricting angles. The viewing angles are generally straight on angles, wherein the line of sight of the user is perpendicular to the first face 22 of the card 20. The restricting angles are generally skew angles or offset angles with respect to the line of sight of the user and the angle of the first face 22 of the card 20. Restricting the information 24 from being viewed helps to prevent the information 24 from being used by an unauthorized person, such as in theft of an account number or cheating in a card 20 game.

The privacy cover 30 may cover 30 a portion of the card 20 or the whole card 20. The privacy cover 30 goes over any information 24 upon the card 20 that is desired to be restricted from view. In various embodiments, the privacy cover 30 may simply be positioned over the lower half of the first face 22, wherein all of the information 24 of the card 20 that is desired to be concealed is upon the lower half of the first face 22. It is appreciated that various other embodiments may also be utilized in positioning the privacy cover 30 upon the card 20 either on the first face 22 or a different face or side of the card 20.

It is appreciated that when the privacy cover 30 is attached to the card 20 and the card 20 is at a viewing angle the privacy cover 30 is substantially unnoticeable. When the card 20 and privacy cover 30 are at a restricted angle, the card 20 appears blackened or substantially darkened so as not to be able to view the information 24.

The privacy cover 30 is preferably comprised of a thin and planar sheet configuration which has transparent properties and also reflective properties so that the user may view the information 24 at viewing angles and prevent the information 24 from being viewed at restricted angles. The privacy cover 30 may be flexible and comprised of various materials, such as plastic. The privacy cover 30 may also be comprised of various products, such as the PRIVACY FILTER sold by 3M™. However, the PRIVACY FILTER sold by 3M™ is generally only able to restrict visibility from either the horizontal (i.e. left and right) or the vertical (i.e. Up and down) direction. A product such as the PRIVACY SCREEN™ used for BLACKBERRY™ device provides restricted visibility in all directions (i.e. both vertically and horizontally) and is preferably utilized with the present invention. It is appreciated that the present invention is able to restrict visibility from all directions (i.e. left, right, up, down) rather than simply from one side or the other so that persons on both the left and right sides of an individual holding an information card 20 including the privacy cover 30 will be restricted from viewing the information 24 upon the information card 20.

The privacy cover 30 may attach to the card 20 in various manners. In one embodiment, the privacy cover 30 includes an attachment layer 35 to attach to the first face 22 or portion of the first face 22. The attachment layer 35 may be comprised of various configurations, such as but not limited to adhesive. In another embodiment, the privacy cover 30 is laminated upon the card 20. In another embodiment, the privacy cover 30 is integral with the information card 20. A second face 32 of the privacy cover 30 (i.e. face in which user views the information 24 through) is parallel to the first face 22 and is aligned with the information 24 upon the card 20.

It is also appreciated that the cover 30 may include differing strengths for different types of cards 20. For example, in a first strength if a credit card 20 is to be utilized a high strength privacy cover 30 may be desired in that the range of viewing angles lessens and the range of restricting angles widens to block views from a larger amount of angles. In another example, in a second strength if a playing card 20 is utilized a lower strength privacy cover 30 may be desired to increase the range of the viewing angles so that when the playing cards 20 are laid down on the table at the end of the hand, all players may adequately view the information 24 upon the cards 20.

### D. Operation of Preferred Embodiment

In use, the privacy cover 30 is positioned over the information 24 of the first face 22 of the information card 20. The privacy cover 30 is then secured to the card 20 via the attachment layer 35, ensuring that the second face 32 of the privacy cover 30 aligns with the information 24 upon the information card 20 that is to be restricted at certain angles. When utilizing the card 20, the information 24 may be viewed through the privacy cover 30 when the card 20 is at a viewing angle and the information 24 is prevented from being viewed when the card 20 is at a restricted angle.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. An information card concealing system, comprising:
an information card; and
a privacy cover attached to said information card over at least a portion of information upon said information card, wherein said privacy cover aligns with said information of said information card, wherein said privacy cover is integral upon said information card;
wherein said privacy cover is adapted to allow viewing of said information of said information card through said privacy cover over a first range of angles and wherein said privacy cover is adapted to prevent viewing of said information of said information card through said privacy cover over a second range of angles.

2. The privacy cover system of claim 1, wherein said privacy cover may be comprised of a plurality of strengths to increase or decrease said first range of angles and said second range of angles.

3. The privacy cover system of claim 1, wherein said information card is comprised of a transaction card.

4. The privacy cover system of claim 1, wherein said information card is comprised of an identification card.

5. The privacy cover system of claim 1, wherein said information card is comprised of a playing card.

6. The privacy cover system of claim 1, wherein said first range of angles are comprised of viewing angles perpendicular with said privacy cover.

7. The privacy cover system of claim 1, wherein said second range of angles are comprised of restricting angles skew with said privacy cover.

8. The privacy cover system of claim 1, wherein said privacy cover is comprised of a flexible configuration.

9. The privacy cover system of claim 1, wherein said privacy cover includes an attachment layer.

10. The privacy cover system of claim 9, wherein said attachment layer is comprised of an adhesive layer.

11. The privacy cover system of claim 1, wherein said privacy cover is attached in a laminate manner to said information card.

12. (canceled)

13. An information card concealing system, comprising:
an information card; and
a privacy cover attached to said information card over at least a portion of information upon said information card, wherein said privacy cover is integral upon said information card;
wherein said privacy cover is adapted to allow viewing of said information of said information card through said privacy cover over a first range of angles;
wherein said first range of angles are substantially perpendicular with said privacy cover;
wherein said privacy cover is adapted to prevent viewing of said information of said information card through said privacy cover over a second range of angles;
wherein said second range of angles are skew with said privacy cover.

14. The privacy cover system of claim 13, wherein said privacy cover may be comprised of a plurality of strengths to increase or decrease said first range of angles and said second range of angles.

15. The privacy cover system of claim 13, wherein said information card is comprised of a transaction card.

16. The privacy cover system of claim 13, wherein said information card is comprised of an identification card.

17. The privacy cover system of claim 13, wherein said information card is comprised of a playing card.

18. The privacy cover system of claim 13, wherein said privacy cover is comprised of a flexible configuration.

19. The privacy cover system of claim 13, wherein said privacy cover aligns with said information of said information card.

20. An information card concealing system, comprising:
an information card; and
a privacy cover attached to said information card over at least a portion of information upon said information card, wherein said privacy cover is integral upon said information card;
wherein said privacy cover is adapted to allow viewing of said information of said information card through said privacy cover over a first range of angles;
wherein said first range of angles are substantially perpendicular with said privacy cover;
wherein said privacy cover is adapted to prevent viewing of said information of said information card through said privacy cover over a second range of angles;
wherein said second range of angles are skew with said privacy cover;
wherein said privacy cover may be comprised of a plurality of strengths to increase or decrease said first range of angles and said second range of angles;
wherein said privacy cover is comprised of a flexible configuration;
wherein said privacy cover is attached in a laminate manner to said information card;
wherein said privacy cover aligns with said information of said information card.
